(19) United States
(12) Patent Application Publication
(10) Pub. No.: US 2011/0047606 A1
(43) Pub. Date: Feb. 24, 2011

(54) Method And System For Storing And Using A Plurality Of Passwords

(76) Inventors: Scott A. Blomquist, Portland, OR (US); Chad Blomquist, Portland, OR (US); Jim Zhen Luo, Springfield, VA (US); Benjamin Stover, Portland, OR (US); Jason Allyn Grlicky, Portland, OR (US); Samuel Wayne Alexander, Portland, OR (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(21) Appl. No.: 12/678,585

(22) PCT Filed: Sep. 17, 2008
(86) PCT No.: PCT/US08/76651

§ 371 Date: Nov. 8, 2010

Related U.S. Application Data
(60) Provisional application No. 60/973,067, filed on Sep. 17, 2007.

(51) Int. Cl. H04L 9/32; G06F 17/00

(52) U.S. Cl. 726/7

(57) ABSTRACT

A system and method for managing a plurality of a user's authentication elements. In a preferred embodiment a user initiates a webpage browser session at a user website access device and activates a password manager program. The user's identity is authenticated to an authentication server and allowed to access a secure database comprising a plurality of website authentication elements. Thereafter, the user accesses a first secure website and the program determines the presence of a user authentication data field. When a user authentication data field is present the program instructs the authentication server to automatically transmit at least one of the authentication elements specific to the authentication data field of the first secure website to authenticate the user to the first website.

### CROSS-REFERENCE TO RELATED APPLICATION

The present application claims the benefit of U.S. Provisional Application No. 60/973,067 filed on Sep. 17. 2007, the contents of which are incorporated herein fully by reference.

### FIELD OF THE INVENTION

The present invention relates generally to the field of user authentication and more particularly to the automatic authentication of users to multiple servers or websites using a single authentication scheme.

### SUMMARY OF THE INVENTION

The present invention is directed to a method for authenticating an identity of user. The method comprises initiating a webpage browser session at a user device and prompting the user to provide an account identifier and an authentication element via the user input device. The account identifier and the anesthetization element are received from the user input device and the identity of the user is authenticated based upon the account identifier and the authentication element received from the user input device. The user is allowed access a secure database comprising a plurality of stored website account identifiers and stored website authentication elements upon authentication. The user device connects to displays a website. The website comprises a prompt to authenticate a website identity of the user to the website and automatically retrieves and transmits the stored website user account identifier and stored website authentication element from the secure database for the specific website displayed.

The present invention is further directed to a system for authorizing a user to a secure website. The system comprises a memory unit, a means for controlling access to the memory unit, and a website access device. The memory unit is adapted to store plurality of website account identifiers and a plurality of website authentication elements for a single user. Each the plurality of secure website account identifiers are associated with only one of the plurality of a website authentication elements. The means for controlling access to the memory unit controls access based upon authentication of an identity of the user to the memory unit. The website access device comprises a means for accessing the memory unit and a communications link between the memory unit and the website. The memory unit is adapted to automatically select a website account identifier and website authentication element specific to the website and transmit the website account identifier and website authentication element to the secure website to authenticate the identity of the user to the secure website.

Further still, the present invention is directed to a computer implemented authentication protocol. The protocol comprises initiating a webpage browser session at a user website access device and authenticating a user identity to an authentication server. A secure database comprising a plurality of website authentication elements is accessed and then a first secure website is accessed and the presence of a user authentication data field is determined. The authentication server thereafter automatically transmits at least one of the plurality of authentication elements specific to the authentication data field of the first secure website to authenticate the user to the first website.

### DESCRIPTION OF THE FIGURES

FIG. 1 is a diagrammatic representation of the authentication system of the present invention showing the use of online and off-line authentication elements.

FIG. 2 is a flow chart illustrating a method of two factor authentication using authentication elements stored offline and online.

FIG. 3 is an exemplary webpage showing a user list of authentication elements stored and accessible using the system and method of the present invention.

FIG. 4 is an exemplary webpage showing a user profile used in accordance with the system and method of the present invention.

### DESCRIPTION OF THE INVENTION

Computer networks, particularly those with global reach such as the Internet, have greatly influenced the way that individuals, companies and institutions conduct transactions, and store and retrieve documents, images, music, and video. Convenience, ease of use, speed, and low overhead costs are contributing factors to the widespread use of the Internet for purchasing goods as well as conducting confidential transactions. Many of the websites used for purchasing goods and conducting confidential transactions as well as social networking websites and news sources require user registration and subsequent authentication of the user's identity before allowing access to the websites features and content.

Secure access to computer systems and computer networks has been traditionally guarded with a username and password pair. Thus, the user may be required to remember several username and password pairs for the multiple websites the user may have use. Because the number of usernames and passwords per single user may become very numerous, users often maintain a local text file or written list of username and password pairs. If the usernames and passwords are not protected, accounts and files can be compromised. Unfortunately, a number of rogue individuals and organizations have emerged that are dedicated to fraudulently obtaining confidential information for unauthorized or criminal activities. Accordingly, there is a need for systems and methods that allow users to access a plurality of websites and web-based accounts without requiring the memorization of a plurality of usernames and passwords.

Security conscious users often have different authentication elements for each website or third-party server they use via the Internet. Even care-free users may have multiple authentication elements such as usernames and passwords. As used herein the term “authentication elements” may comprise traditional usernames and passwords, site key image and other elements, and authentication image categories as described in co-pending U.S. patent application Ser. No 11/420,061 entitled Graphical Image Authentication and Security System, the contents of which are incorporated herein by reference. Accordingly, memorization of authentication elements has become increasingly impractical. As a result, many users use the same authentication elements for multiple websites or write down their authentication elements or store them in a text file on their PC or mobile device. Thus, a need has developed for a system and method which allows users to secure access to their multiple accounts via a single authentication session without requiring memorization of multiple authentication elements. The present invention is directed to a method and system that allows a user to store the user's entire collection of authentication elements in a secure memory unit comprising an electronic file either online or offline for automated retrieval and use upon logging into a website.

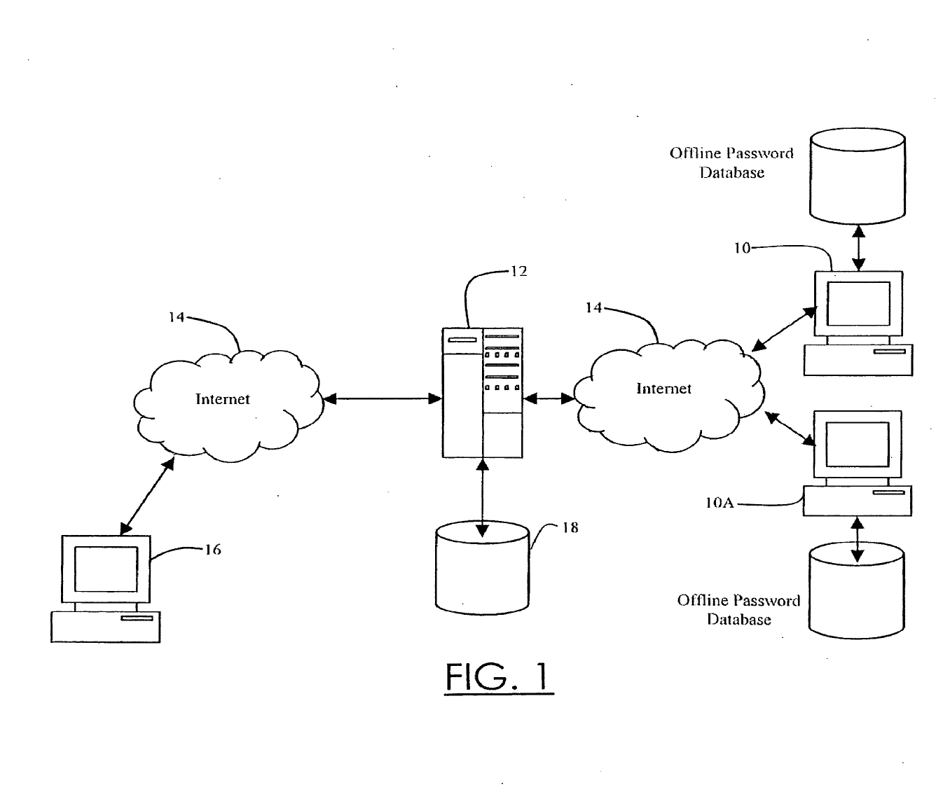

With reference now to the Figures, and more specifically to FIG. 1. FIG. 1 is a diagrammatic representation of general environment in which the present invention operates. FIG. 1 illustrates that a first user device comprising a personal computer 10 or other website access device may be in communication with a means for controlling access to the memory unit 12 such as an authentication server via the Internet 14. As used herein “user device” or “user website access device” may be used interchangeably and may comprise at least one of a personal computer, a cellular telephone, a personal digital assistant or an Internet enabled game console.

The authentication sever 12 comprises a means for controlling access to the memory unit and is adapted to receive an account identifier and authentication element from the user's website access device 10 and to authenticate the user upon validation of the account identifier and the authentication element. Further, the authentication server 12 provides an authentication gateway to a plurality of third-party websites or servers 16 as described in more detail in co-pending U.S. Patent application No. 60/915,841 entitled Method and Apparatus for Queuing User Action Prior to Authentication filed May 3, 2007, the contents of which are incorporated herein by reference.

The third-party server 16 may comprise a web server for a financial institution, a web based business, a brick and mortar retailer or service provider or any other type of website or web-based service that requites user authentication prior to allowing access to the content provided through such website. Accordingly, one skilled in the art will appreciate that the term third-party website or server may include any sever accessible via the Internet 14 which is adapted to require or include user authentication.

In accordance with the present invention, the authentication server 12 is adapted to store a plurality of the user's authentication elements (passwords and usernames) used to login to the third-party websites in secure database. The authentication elements stored at the authentication server may comprise a plurality of website account identifiers and a plurality of website authentication elements for a single user. Each of the plurality of secure website account identifiers are associated with only one of the plurality of the website authentication elements. These authentication elements are stored in a memory unit comprising a secure database 18 accessible via the Internet 14. Storage of authentication elements online at the authentication server 12 allows the user to authenticate to selected third-party websites from any machine having access to the Internet 14 without requiring the user to memorize or carry the corresponding third-party authentication elements.

The memory unit or set of offline authentication elements may likewise comprise a secure file stored pan an electronic file storage device locally at the website access device 10. The authentication elements are stored in a location of the user's selection on the user machine 10 and are encrypted for access using a key generated by the password vault program and accessible only from the authentication server upon authentication of the user to the authentication server 12.

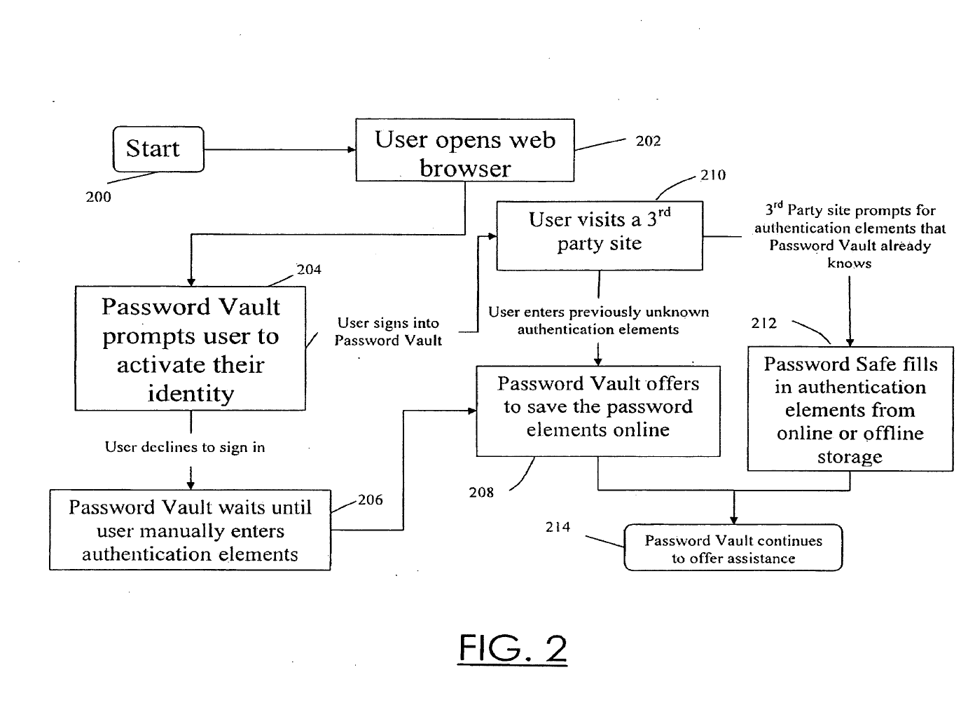

A central component of the present invention comprises a program present on the user's computer and adapted to communicate with the authentication server to manage the user's authentication to third-party web servers. For purposes of illustration the program if the present invention is referred to generally herein as the “password vault program.” The program comprises a plug-in downloaded to the user's machine which in addition to managing the secure database 18 and authentication elements, the program also manages cryptology of the user's authentication server and third-party websites. The program is adapted to manage the authentication elements in a file stored locally on the user's hard disk. One skilled in the art will appreciate that the local file may also be stored and accessed from a portable electronic file storage medium or device such as a floppy disk. CD-ROM, or flash drive. Maintaining the authentication element file on a portable storage device allows the user to access third-party websites from other website access devices 10A utilizing the two-factor authentication regime provided by the authentication server and locally stored program. The way in which the present program functions will be further discussed with reference to FIG. 2.

Turning now to FIG. 2, a partially automated two factor authentication process in accordance with the present Invention will he discussed. At Step 200 the process begins and the user initiates a webpage browser session using a user website access device at Step 202. At Step 204 the program, which may comprise a plug-in provided by the authentication server entity, prompts the user to activate its password vault identity by providing an account identifier and an authentication element via the user input device 10/10A. The user may activate its password vault identity by authenticating to the authentication server 12 using the authentication method and system described in co-pending U.S. patent application Ser. No. 11/677,562 entitled Methods and System for Graphical Image Authentication filed Feb. 21, 2007 the contents of which are incorporated herein by reference. Alternatively, authentication of the user to the authentication server may comprise verification of the user's account name and password.

An authentication prompt appears on the user's screen upon accessing the machine's Internet browser and may be configured to automatically appear each time the web browser is accessed. During Step 204 the user is allowed to sign in, change users, or select “no”. If the “sign in” option is selected, the user is directed to the password vault authentication website for authentication or automatically presented with the authentication server's authentication challenge. For example, the user may be directed to the password vault website and asked to enter its username. After entry of the username the user is then challenged to entry the require authentication element in the form of a password or image category identifier as disclosed in co-pending U.S. patent application Ser. No. 11/677,562 entitled Methods and System for Graphical Image Authentication filed Feb. 21, 2007, Once authenticated to password vault account the user is granted access to the secure database comprising the plurality of stored website account identifiers and associated authentication elements. Further, in one embodiment of the present invention, the user may be directed to an account management page or the third party website the user originally intended to visit. Thereafter the password vault program or authentication server will automatically retrieve and transmit the stored website user account identifier and stored website authentication elements from the user's secure database file for the specific website displayed. It will be appreciated that any one user may have authentication elements stored both online and offline. The password vault plug-in is programmed to recognize the third-party website requesting authentication of the user's identity and to determine the location of the authentication elements of the site specific authentication elements in the user's overall account profile whether stored online, offline, or both. Thus, the user is provided with automated logon when the user visits third-party websites the user has stored in its password vault online or offline accounts.

If the user selects the “change user” option, the user is directed to the authentication server web interface and required to enter the username corresponding to its password vault account. The user may then authenticate to its password vault account by entering the required authentication element. Once authenticated, the password vault program will automatically authenticate the user to third-party websites that require use authentication and for which the user has stored the corresponding authentication elements for said third-party websites in the user's password vault.

The user may also select “No” when prompted at Step (204) and decline to authenticate to the authentication server, in which ease the password vault program will standby (Step 206) until the user manually enters authentication elements in response to a third-patty's authentication challenge. Upon entering authentication elements into the third-party's website, the program of the present invention will provide the user a prompt (Step 208) offering to save the entered authentication elements in the authentication server's online password vault database 18. If the user selects to save the authentication elements for later use, the next time the user visits the third-party website the program will automatically fill-in the required fields of the website's authentication challenge. The user may be notified that the program is automatically entering the authentication elements by the presence of an icon, such as the Vidoop ImageShield™, in each field of the third-party authentication challenge. The absence of this notification symbol alerts the user to the fact that it is not properly authenticated to the authentication server. The presence of the notification symbol alerts the user to the fact that the password vault program is accessing the user's stored authentication elements.

In the event the user elects to log into the authentication server at Step 204 and visits a third-party website (Step 210) the program of the present invention actively monitors the user's activity and provides assistance in authenticating the user to third-party websites accessed during the user's web session. If the third-party website is one that has been visited previously by the user and the authentication elements required for access to the third-party website have been stored for use in the user's offline or online secure database, the program will automatically fill-in the required authentication elements front the online or offline storage (Step 212). Upon authentication to the third-party website, the password vault program of the present invention will disappear front the user's view yet continue to monitor the user's activity and offer assistance again (Step 214) when the user is subsequently prompted for authentication. However, the program may be configured to visually communicate that the user is authenticated to the authentication server 12 and is operating with the password vault by the presence of a notification symbol on the web browser. For example, a lock or security icon, in the form of the Vidoop ImageShield™, may appear in the browser's security notification field. This icon may also function as a link to the authentication server providing the user quick access to the authentication server's authentication pace. In such case, the notification icon may appear in an altered state, such as a grey colored Vidoop Shield design icon, to alert the user that the authentication program and password vault are present on the machine but that the user has not activated the password vault by authenticating its identity.

The password vault program is further adapted to, when activated by authentication of the user's identity, monitor the user's web session and identify instances where the user is authenticating to a third-party website that is not already stored in the user's online or offline directory. In this instance, the user enters the previously unknown authentication elements and the password vault program offers to save the authentication elements on the user's online password vault (Step 208). Allowing the password vault program to save the authentication elements to the user's account triggers the program to create a website entry in the user's secure database file where the third-party website URL is automatically saved to the user's account. Further, the user account name and password or other authentication element may be automatically saved to the user's online secure database file. This account information is then accessible via the user's password vault “Sites” webpage, discussed hereinafter, for further editing or to allow the user to move this information to the user's offline secure database file.

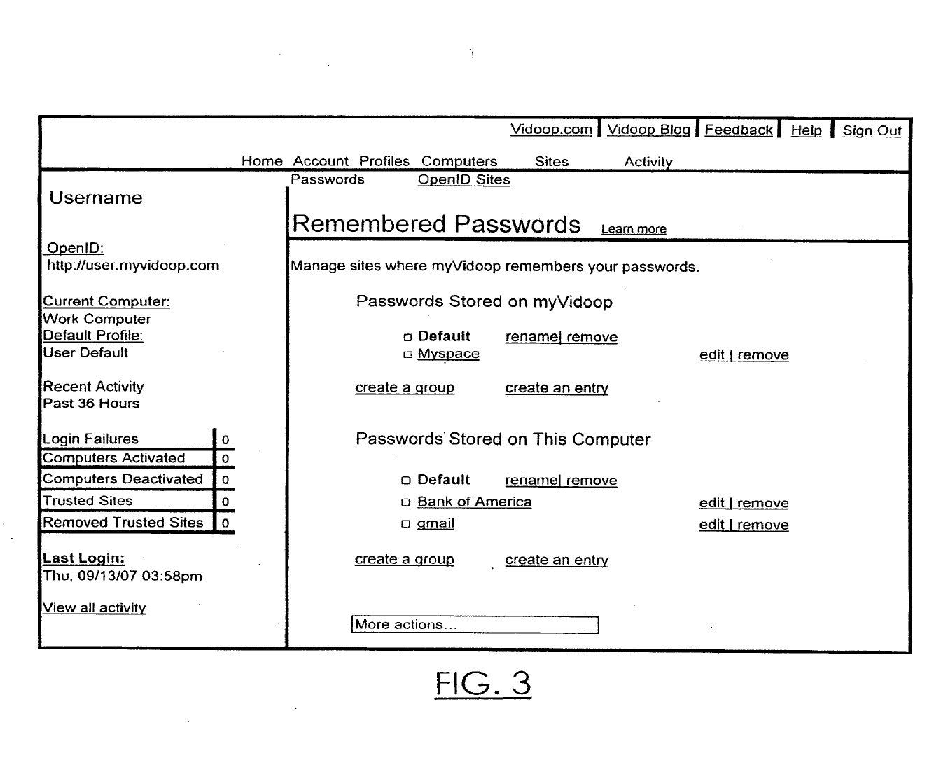

Turning now to FIG. 3, there is shown therein a user's third-party website management page. Once authenticated to the password vault program, the user is granted access to all of its online authentication elements from any machine with Internet access. Access is not however granted to the user's offline authentication elements unless the user's encrypted secure database file comprising its authentication elements is stored on the machine presently in use or the user has downloaded the ilk to the machine or otherwise given the local machine access to the user's offline secure database tile. The webpage reproduced as FIG. 3 provides the user a web-based interface for managing its passwords. The exemplary webpage provides the user with a “Remembered Passwords'' section wherein the user is able to add websites into either its online password vault, “Passwords Stored on myVidoop,” or its offline password vault, “Passwords stored on This Computer”. The user is provided with tools allowing it to move websites between the online and offline database tile, to remove websites altogether, to edit the information contained within each database to update or change the authentication elements used to access the third-party sites. The user is further provided with information related to recent activity in the user's account such as login failures, computers activated, computer deactivated, trusted sites and removed trusted sites. For purposes of this disclosure, the terms “trusted sites” refers to third-party websites that are stored in the user's secure database.

For purposes of illustration only, three third-party websites are shown in FIG. 3 as trusted sites. Third-party websites and accounts which the user considers low risk, i.e. websites that do not contain sensitive personal or financial information such as networking or news sources may be placed in the online database so that the user's authentication elements used to access the sites are stored on the authentication server and accessible via the Internet from any device capable of accessing the authentication server's website. The section entitled “Passwords Stored on This Computer” is provided to allow the user to mange websites containing to providing access to sensitive information such financial information or the user's general e-mail account. This portion of the site allows the user to direct the location at which the authentication elements for these sensitive websites are stored.

The user may select the “create an entry” link located towards the bottom of the page. Upon clicking this link the user is provided with a page containing fields used to create the new entry. The user is asked to provide the following information: (1) a name far the entry; (2) a group within which to place the entry, if applicable; (3) the username used to access the third-putty account; (4) the password or other authentication element used by the third-party site to confirm the user's identity; (5) the URL at which the user is able to access its third-party account; and (5) any notes the user needs to associate with the account for later access. The user is also prompted to select an “auto submit” option that instructs the password vault program to automatically provide the third-party website with the user's authentication elements when the user visits the third parties website. Once the requested information has been provided, the user clicks the “Save” button,. When first saved the new website and authentication elements may automatically be saved to the user's online secure database. However, the user may subsequently select the “edit” link next to the entry. The user is then presented with a link that directs the administration program to move the authentication elements to the user's offline secure database tile. Upon clicking the “store this password on this computer” link the authentication elements are removed from the user's online secure database file and stored in the user's offline secure database tile at the location specified by the user.

As an additional feature of the present invention, the user's site management webpage also allows the user to view authentication elements used to access third-party sites. The user may select the “edit” link next to the “Gmail” link shown in FIG. 3. Upon clicking this link the user is presented with a page that shows the website name, the user's account name, the URL, and the password hidden using multiple asterisks. The user may however, click the “show” link next to the hidden website to reveal the actual password corresponding the user's third-party account name. This feature is particularly helpful in a situation where the user is attempting to access a third-party website using a public access machine or using a machine as a guest user. The user may authenticate itself to the authentication server via the password vault web interface and access each of its online stored passwords even if the password vault program has not been installed the machine thus eliminating the need for the user to remember each of the authentication elements used to access its various third-party accounts.

The webpage shown in FIG. 3 also provides the function of “book marking” the third-party websites stored in the user's password vault account. As shown in FIG. 3, the user may click the link provided to any one of its stored websites and the user will be directed to the selected website. For purposes of illustration, the use nay select the “Gmail” link and will be directed to the Google mail (web-base e-mail) logon website. The user will next see the “Google Mail” logon page which will appear with the user's account, name and password auto-filled into the appropriate fields. The user will also be presented with a notification icon in each field auto-filled by the password vault program to visually verify the user is logged into the password vault program. The notification also provides the user with visual verification that each site stored within the safe and warns the user if the site URL does match the stored value.

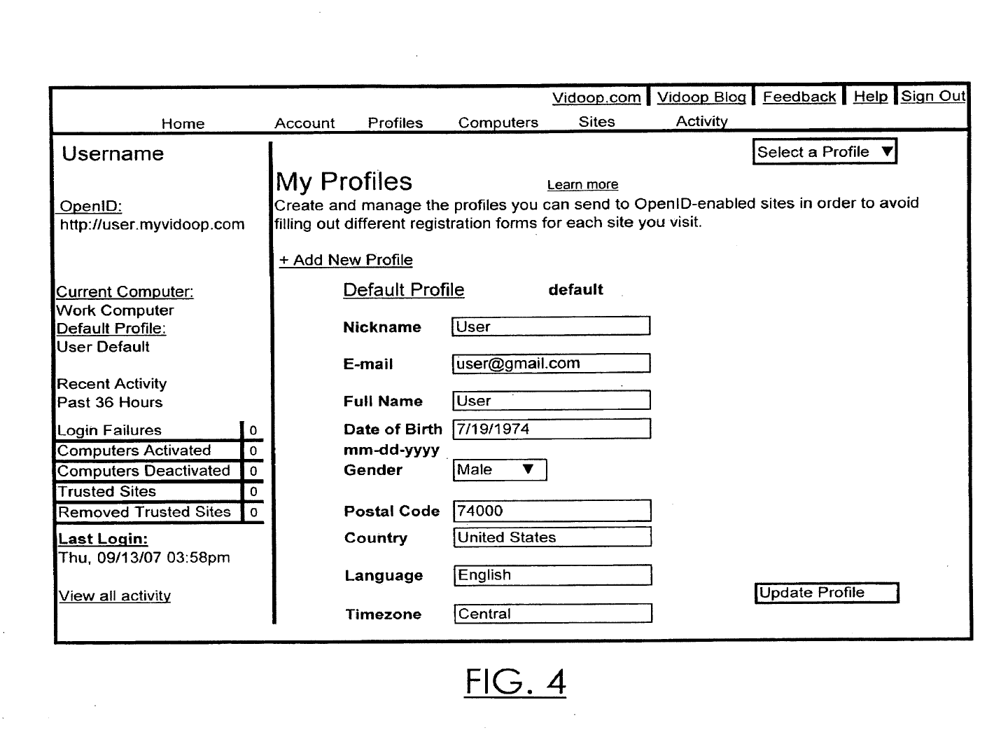

The “Sites” page of the password vault program also allows the user to manage websites accepting OpenID authentication protocol. The sites accepting authentication via OpenID may be characterized as “trusted sites”. This authentication protocol may, however require the third-party and the authentication server to enter into a trust relationship which allows users with OpenID authentication profiles to authenticate to the third-party site using the OpenID protocol. Accordingly, the password vault authentication web site provides the user with a profile management page (FIG. 4) that allows the user to manage multiple online profiles for use with OpenID authentication third-party sites.

The password vault program allows the user to fill in profile information for storage in the users online or offline secure database files. This information may then be used by the password vault program when the user signs into an OpenID-enabled site, to optionally have the password vault program transmit information that the user would otherwise have to enter on the website itself as a part of the registration process. Thus, the authentication server database contains the profile information that it can store and send to these OpenID enabled sites.

The method presented herein further comprises a computer implemented authentication protocol. The protocol comprises initiating a webpage browser session at a user website access device 10. The user's identity is then authenticated to an authentication server 12 as described herein. The user is allowed to access a secure database comprising a plurality of website authentication elements for user as described hereinabove.

Next, the user is either redirected to its intended third-party website or accesses a first secure website and the presence or a user authentication data field on the website is determined. When the authentication data field is detected by the password vault plug-in the authentication server is instructed to automatically transmit at least one of the plurality of authentication elements specific to the authentication data field of the first secure website to authenticate the user to the first secure website.

The protocol further includes accessing a second secure website during the webpage browser session and determining the presence of a user authentication data Upon detection of the data field on the second secure website, the authentication server automatically transmits at least one of the plurality of authentication elements specific to the authentication data field of the second secure website to authenticate the user to the second secure website.

Various modifications can be made in the design and operation that the present invention without departing from the spirit thereof. Thus, while the principal preferred construction and modes of operation of the invention have been explained in what is now considered to represent its best embodiments, which have been illustrated and described, it should be understood that the invention may be practiced otherwise than specifically illustrated and described.

What is claimed:

1. A method for authenticating an identity of a user, the method comprising:
initiating a webpage browser session at a user device;
prompting, the user to provide an at identifier and an authentication element via the user input device;
receiving the account identifier and the authentication element from the user input device;
authenticating the identity of the user based upon the account identifier and the authentication element received from the user input device and allowing the user access a secure database comprising a plurality of stored website account identifiers and stored website authentication elements:
the user device connecting to and displaying a website, the website comprising a prompt to authenticate a website identity of the user to the website; and
automatically retrieving and transmitting the stored webs to user account identifier and stored website authentication element from the secure database for the specific website displayed.

2. The method of claim 1 wherein the account identifier comprises a user identification name.

3. The method of claim 1 wherein authenticating the user comprises:
receiving the account identifier;
displaying randomly generated grid of randomly selected images, each image having at least one randomly generated unique authentication element comprising an image identifier associated therewith; wherein at least one of the images is from a pre-selected category corresponding to the account identifier;
receiving at least one randomly generated unique image identifier associated with the image from the pre-selected image category; and
authenticating identity based upon the received unique image identifier associated with the randomly selected image from the pre-selected category.

4. The method of claim 1 wherein the user device comprises at least one of a personal computer, cellular telephone, a personal digital assistant or a Internet enabled game console.

5. The method of claim 1 further comprising:
displaying a second website comprising a prompt to authenticate a second website identity of the user to the website;
automatically retrieving and transmitting, to the second website, a stored user account identifier and a stored second website authentication element both specific to the user and the second website from the secure database for authentication of the user by the second website.

6. The method of claim 5 wherein the stored account identifier and stored website authentication element comprise OpenID authentication credentials.

7. The method of claim 1 wherein the secure database is stored at the user device.

8. The method of claim 1 wherein the secure database is stored at an electronic storage device remote from the user device.

9. The method of claim 1 wherein the secure database comprises an online component and an offline component, wherein the offline component is stored at the user device and the online component is stored at an electronic storage device for access from a plurality of user devices via a network connection.

10. The method of claim 1 wherein displaying the website further comprises displaying an authentication notification icon, proximate to the prompt to authenticate the website identity, wherein the authentication notification icon communicates automatic retrieval and transmission of the stored website user account identifier and stored website authentication element further comprising displaying an authentication.

11. The method of claim 1 further comprising displaying an authentication notification icon proximate to the prompt to authenticate the website identity subsequent to authenticating the identity of the user and allowing access the secure database.

12. A system for authorizing a user to a website, the system comprising:
a memory unit for storing a plurality of website account identifiers and a plurality of website authentication elements for a single user, wherein each of the plurality of secure website account identifiers are associated with only one of the plurality of the website authentication elements;
a means for controlling access to the memory unit based upon authentication of an identity of the user to the memory unit; and
website access device comprising a means for accessing the memory unit and a communications link between the memory unit and the website;
wherein the memory unit is adapted to automatically select a website account identifier and website authentication element specific to the website and transmit the website account identifier and website authentication element to the secure website to authenticate the identity of the user to the secure website.

13. The system of claim 12 wherein the memory unit comprises a secure file stored on a electronic file storage device at the website access device.

14. The system of claim 12 wherein the memory unit comprises a secure file stored on a electronic file storage device at a third-party computer system in communication with the website and the website access device.

15. The system of claim 12 wherein the means for controlling access to the memory unit comprises an authentication server adapted to receive an account identifier and authentication element from the website access device and to authenticate the user upon validation the account identifier and authentication element.

16. The system of claim 15 wherein the authentication server comprises:
a processor adapted to generate a grid of randomly selected images for display on the website access device and to assign a different randomly selected authentication element comprising a unique image identifier to each of the randomly selected images for display with the image on the website access device; and
wherein the processor is adapted to receive at least one alphanumeric character from a user input device corresponding to the unique image identifier to authenticate the user.

17. The system of claim 16 wherein the randomly selected images are selected from a plurality of image categories, at least one category comprising an authenticating category, and wherein the user input the image identifier assigned to the randomly selected image from the authenticating category.

18. The system of claim 16 wherein the grid of randomly selected images comprise at least one image from a pre-selected image category.

19. The system of claim 12 wherein the memory unit comprises a portable read/write memory device.

20. The system of claim 12 wherein the website access device is selected from the group comprising a personal computer, a personal digital assistant, a cellular telephone, or a gaming console.

21. The system of claim 12 wherein the memory unit comprises an online component and an offline component, wherein the offline component comprises a secure database of high priority set of website account identifiers and website authentication elements stored at the user device and wherein the online component comprises a secure stored at an electronic storage device for access from a plurality of user devices via an network connection.

22. A computer implemented authentication protocol comprising:
initiating a webpage browser session at a user website access device;
authenticating a user identity to an authentication server;
accessing a secure database comprising a plurality of website authentication elements;
accessing a first secure website and determining the presence of a user authentication data field; and
the authentication server thereafter automatically transmitting at least one of the plurality of authentication elements specific to the authentication data field of the first secure website to authenticate the user to the first website.

23. The computer implemented authentication protocol of claim 22 further comprising:
accessing a second secure website and determining the presence of a user authentication data field; and
the authentication server thereafter automatically transmitting at least one of the plurality of authentication elements specific to the authentication data field of the second secure website to authenticate the user to the second secure website.

24. The computer implemented authentication protocol of claim 22 wherein the secure database is stored at the user web access device.

25. The computer implemented authentication protocol of claim 22 wherein the secure database is stored by the authentication server.

26. The computer implements authentication protocol of claim 23 further comprising displaying an authentication notification icon proximate to the authentication data fields of the first secure website and the second secure website subsequent to authenticating the user identity to the authentication server.

27. The computer implements authentication protocol of claim 22 further comprising displaying an authentication notification icon proximate to the any authentication data field of any secure website subsequent to authenticating the user identity to the authentication server.
